(19) United States
(12) Patent Application Publication
(10) Pub. No.: US 2026/0065303 A1
(43) Pub. Date: Mar. 5, 2026

(54) REAL TIME TRAINED PREDICTIVE TIME SERIES MODEL

(71) Applicant: NCR Voyix Corporation, Atlanta, GA (US)

(72) Inventors: Noa Shmulevich, Haifa (IL); Shiran Abadi, Tel-Aviv (IL)

(21) Appl. No.: 18/961,886

(22) Filed: Nov. 27, 2024

Related U.S. Application Data
(63) Continuation-in-part of application No. 18/821,459, filed on Aug. 30, 2024, now abandoned.

(51) Int. Cl. G06Q 30/0202

(52) U.S. Cl. CPC G06Q 30/0202

(57) ABSTRACT

System and techniques may be used for generating a predictive time series of sales data. An example technique may include training a generic time series model including a non-symmetric logistic regression to generate a trained model that applies to a particular store by optimizing a parameter of the regression. The technique may include storing the generating predicted cumulative sales data for a first time of a sales day using cumulative sales data, determining a ratio between real cumulative sales at the first time and the predicted cumulative sales at the first time, and modifying the optimized parameter based on the ratio. The technique may include generating updated predicted cumulative sales data for a second time using the modified optimized parameter, and outputting a graph representing the updated predicted cumulative sales data for the second time.

### CLAIM OF PRIORITY

This application is a Continuation-in-Part of U.S. application Ser. No. 18/821,459, filed Aug. 30, 2024, titled “REAL TIME TRAINED PREDICTIVE TIME SERIES MODEL”, which is hereby incorporated herein by reference in its entirety.

### BACKGROUND

Sales data is a useful component of retail operations, providing valuable insights into business performance and customer behavior. It typically includes information such as transaction amounts, item quantities sold, timestamps, and store locations. Sales data is often used to analyze trends, make informed decisions, and forecast future sales patterns.

### SUMMARY

In various embodiments, methods and systems for generating a predictive time series of sales data that can be adjusted in real time based on recent sales data such that the impact of retailer sales decisions can be gleaned in real time are presented.

According to an embodiment, a technique may include training a generic time series model including a non-symmetric logistic regression to generate a trained model that applies to a particular store, where such training may include retrieving historical sales data for the particular store and optimizing a parameter of the non-symmetric logistic regression. The technique may further include storing the optimized parameter of the trained model, receiving a request for an updated sales forecast at a first time of a sales day of the particular store, generating predicted cumulative sales data for the first time using cumulative sales data of the sales day up to the first time, the optimized parameter, and the trained model, determining a relationship between real cumulative sales at the first time and the predicted cumulative sales at the first time, and modifying the optimized parameter based on the determined relationship. The technique may additionally include generating updated predicted cumulative sales data for a second time using the modified optimized parameter, rendering a graphical representation of the real cumulative sales at the first time and the updated predicted cumulative sales data for the second time, and outputting the graphical representation for display on a user interface in response to the request for the updated sales forecast.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a system for generating a predictive time series of sales data in accordance with some embodiments.

FIG. 2 illustrates generally a user interface for requesting a sales prediction in accordance with some embodiments.

FIGS. 3-4 illustrate generally example graphs of projected sales data in accordance with some embodiments.

FIG. 5 illustrates generally a flowchart showing a technique for generating a predictive time series of sales data in accordance with some embodiments.

FIG. 6 illustrates generally an example of a block diagram of a machine upon which any one or more of the techniques discussed herein may perform in accordance with some embodiments.

### DETAILED DESCRIPTION

The systems and techniques described herein provide a predictive time series of sales data for a particular store or set of stores. Forecasting, in real-time, sales of a store for an end of a sales day or other later time can provide up-to-the-minute financial insight, helping a retailer make a quick pricing adjustment or cash flow management decision. Forecasting models are typically used for day-by-day forecasting. Minute-by-minute sales are generally too noisy and existing minute-by-minute models are not robust enough to handle the small extreme fluctuations. Moreover, their training takes a long time and therefore cannot be run quickly or in real-time to take into account new effects or derived shifts that were not known at the time of training. The systems and techniques described herein provide a time series model to predict the sales of the stores at each time of the sales day until closing time. The model may be pretrained over a particular store's past commercial data and adjusted in real-time to current day sales.

For example, when a retail operator is notified at 6 pm that the forecast for the sales at the end of the day will be $100K but the target is $120K, the retail operator may take actions to increase sales. Once a change is made, for example offering of a promotion, the retail operator may be able to see the effect of this action on the sales in real-time. As used herein, a particular store may refer to a single store or to a group or set of stores (e.g., all stores of a chain, stores of a chain in a particular location, stores of a chain owned by an entity, or the like). A particular store may refer to a retail store, a restaurant, etc. A sale may refer to a product, a service, or the like, measured by cash amount, quantity, etc.

The systems and techniques described herein may be used for forecasting sales amounts (e.g., hourly sales, minute by minute sales, etc.) based on past and real-time data. For example, sales for the rest of a sales day until end-of-day may be predicted. When assuming a cumulative sales pattern over a day, the sales day may start with zero sales for some period of time (until store opening time), or may have pre-sales or sales recorded after the end of a previous sales day. An increase in sales begins as sales start being made, and the cumulative sales grows at an amplitude that is relative to the sales rate of the store during the day. Towards the evening, the sales amount converges until closing time. This behavior, between opening time and closing time, can be expressed by a logistic regression function (see, e.g., Equation 1 below). The time until opening or the time after store closing can be portrayed by a constant tail, that trims the logistic regression function at these hours (otherwise, the logistic regression may reach some parameter at infinity or may decrease below zero at minus infinity). The described function (hereafter referred to as “the non-symmetric logistic regression function”) may adjust a prediction for a future time based on recent data, rather than only previous day data.

The systems and techniques described herein may be used to solve a technological problem of how a retailer can judge an impact of selling behavior in real time as it unfolds. The technical solution embodied in the systems and techniques described herein provide a model that a retailer may use in real time to generate a prediction of the impact of modified selling behavior as it occurs (e.g., a promotion started mid-day to increase sales may be used to modify sales that are projected to be lower than anticipated). These systems and techniques further solve the technical problem associated with existing sales prediction models that provide mere sales forecasting but are not sensitive enough to incorporate recent retailer actions (e.g., intra-day) into a forecast. The technical solution of these systems and techniques may include a model that is more computationally lightweight than existing models, providing faster results or using less power.

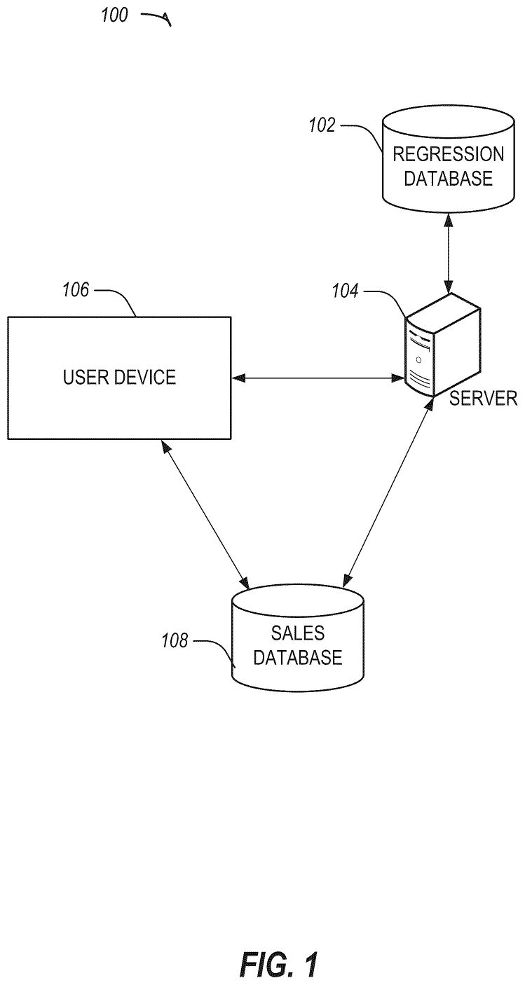

FIG. 1 illustrates a system 100 for generating a predictive time series of sales data in accordance with some embodiments. The system 100 includes a server 104 in communication with a user device 106. The user device 106 may request sales prediction data (e.g., via a website) and the server 104 may send prediction data for a sales day (e.g., a graphical representation, text, or some other indication of future predicted sales projections). In some examples, the server 104 may push the predicted sales data to the user device 106 periodically.

The server 104 may retrieve information (e.g., parameters for the non-symmetric logistic regression function) from a regression database 102. The information in the regression database 102 may be specific to a store corresponding to the user device 106. For example, each store serviced by the server may have its own parameters based on previous sales information.

The user device 106 may send sales data (e.g., in real-time) to a sales database 108 for storage or use by the server 104. The server 104 may retrieve the information from the sales database 108 and use it to generate a predicted future sales projection. In other examples, the user device 106 may send updated sales data to the server 104, which may store the data in the sales database 108. In some examples, the regression database 102 and the sales database 108 are a single database. In other examples, the regression database 102 or the sales database 108 are stored at the server 104, in more than one server, in more than one database, etc.

The server 104 may use the non-symmetric logistic regression function—with parameters selected based on previous days sales data for a particular store corresponding to the user device 106—to generate a future sales projection for a particular sales day for the particular store. The server 104 may use the non-symmetric logistic regression function to generate a sales projection based on sales data for the particular store on a current day up to a current time when the sales projection is generated.

In some examples, the sales database 108 may store sales numbers for a current day only. For example, after a current sales day ends, sales data may be deleted from the sales database 108. The regression database 102 may be configured to store parameters generated from prior sales data. In other examples, either database 102 or 108 may store sales data for a period of time, for example a month, a year, etc.

An example non-symmetric logistic regression function is shown in Equation 1, below. This non-symmetric logistic regression function may be used to generate a projection of sales data at a future time in a current day based on sales that have already occurred in the current day. Equation 1 includes:
the non-symmetric logistic regression function (x)

$$= \{ \begin{matrix}0 & x < {left}_{boundary} \\ L * \frac{1}{1 + {e}^{k * ( x - x 0 )}} + b & {left}_{boundary} \leq x \leq {right}_{boundary} \\ L * \frac{1}{1 + {e}^{k * ( {right}_{boundary} - x 0 )}} + b & x \geq {right}_{boundary}\end{matrix} \qquad Equation 1$$

In Equation 1, k, L, b, x0, left_{boundary}, and right_{boundary} are function parameters that are fitted to observed data. The parameters k, L, b, and x0 of the logistic regression part define the amplitude, maximum at infinity, minimum at minus infinity, and symmetry point, respectively. The parameters left_{boundary} and right_{boundary} define the points at which the horizontal or vertical lines intersect with the logistic regression part, and most commonly are the open and close times of the store. The function result is the sales prediction at a time x of the sales day. Typically, the first part of the function (until x reaches left_{boundary}) is zero, but can be non-zero, for example, when a store has a pre-sale or sales that occurred after a previous day closing. A training dataset may be used to generate or modify the parameters k, L, b, x0, left_{boundary}, or right_{boundary}, as described in more detail below.

An example training dataset includes cumulative sales per day (e.g., over a period of days, such as a week, a month, a year, etc.) and a time interval. The time interval may be indicated in the example training dataset as every minute, every second, every hour, every fifteen minutes, every half hour, or the like. The time interval can be small or large where a relatively smaller interval leads to a more accurate model but can require more resources (e.g., processing power or cooling). A relatively larger time interval, such as an hour, can be used, for example when an error of plus or minus one hour is selected. In an example, seven days of training data may be used to select a parameter. Given the parameters of the non-symmetric logistic regression function (e.g., L, k, x0, or b), and left and right boundaries (e.g., 6:30 and 22:00 as opening and closing time of the store, etc.). The logistic regression function is a function of x (e.g., the time of day 00:01, 00:02, . . . , 23:59).

In an example, until left_{boundary}, the store was closed, and the sales amount are the starting amount, normally 0, but can be somewhat higher if for some reason the store started at a higher sales amount. For example, there was a sales after the store closed the previous business date and this was the amount for hours until the official opening. After right boundary, the store will be closed and the sales amount stays constant, for example it is the amount of the function as it was at right boundary at the end of day.

Between the left and the right boundaries, the growth in sales amount is defined by the logistic regression function with parameters L, x0, k, b, as a function of x. These parameters determine the height of the logistic regression model at plus and minus infinity, the symmetry point, or the amplitude of the function.

The logistic regression function may be fitted to training data (e.g., the training dataset described above) using an optimization technique (e.g., least squares minimization, maximum likelihood, or the like) to determine optimized values for the function parameters (e.g., L, x_0, k, b, left_{boundary}, right_{boundary}). The parameters may be stored for the non-symmetric logistic regression function to be computed in real-time to output a sales projection.

The non-symmetric logistic regression function can be provided (e.g., via a website, an application, etc.) to a store operator, such as by a dashboard or an application programming interface (API). When an updated forecast is requested (e.g., by a user or via a trigger such as a time event), the non-symmetric logistic regression function is initiated, for example at the server 104. The non-symmetric logistic regression function may aggregate a cumulated sales amount for a current sales day of the particular store, such as via a minute-by-minute time series until a current time. The time series may be constructed such that an exact time of a sale is not stored. For example, the time series may be smoothed out before computing, such as by smoothing each sale to the nearest minute, five minutes, fifteen minutes, hour, etc. The smoothing may include generating a curve, for example by taking sales up to a current time and fitting a curve, which may be weighted (e.g., more recent sales weighted higher), or the like.

The server 104 may use the stored parameters to create a suggested forecast for the current time. The server 104 may compute a relationship, such as a ratio between real cumulative sales and predicted cumulative sales at the current time (factor). The server 104 may modify the optimized parameters such that L_new=factor*L, b_new=factor*b. In an example, only the L and b parameters are adjusted since they affect the function's height, while the other parameters (k, x0, left_{boundary}, and right_{boundary}) were fitted at training time and are less likely to change at real time. The factor for L and b may be a same factor or a different factor. The factor multiplication adjusts a height of the non-symmetric logistic regression function to current observations (e.g., sales data for the current day). The server 104 may compute or recompute a real-time prediction using the non-symmetric logistic function with the optimized parameters and the modified L or b.

In an example, the accuracy of the regression model increases as more data is accumulated during the sales day. For example, in early hours of a sales day, the model can be used as is or adjusted to a sales forecasting model that gives the total forecast until end of day. In later hours of the sales day, the regression model is more accurate.

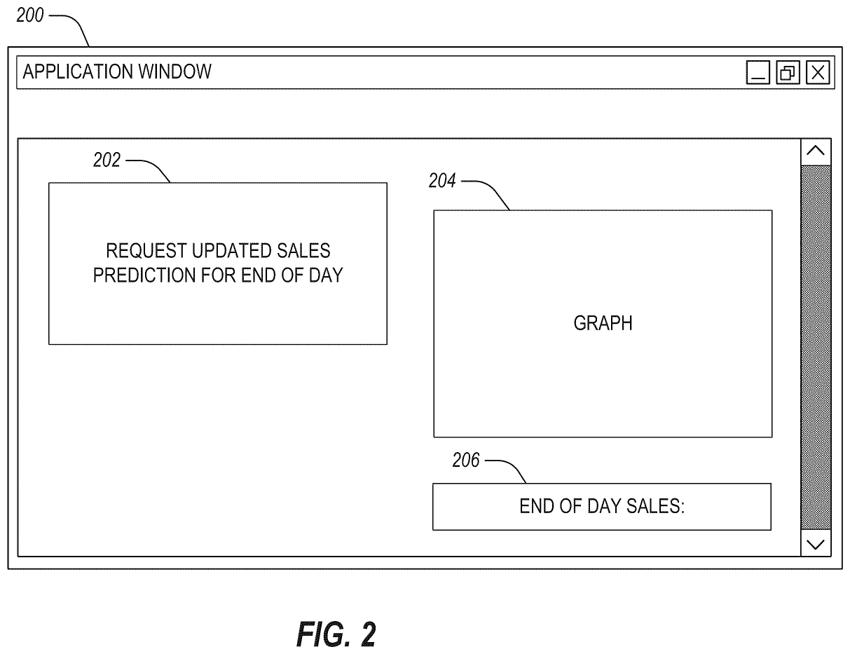

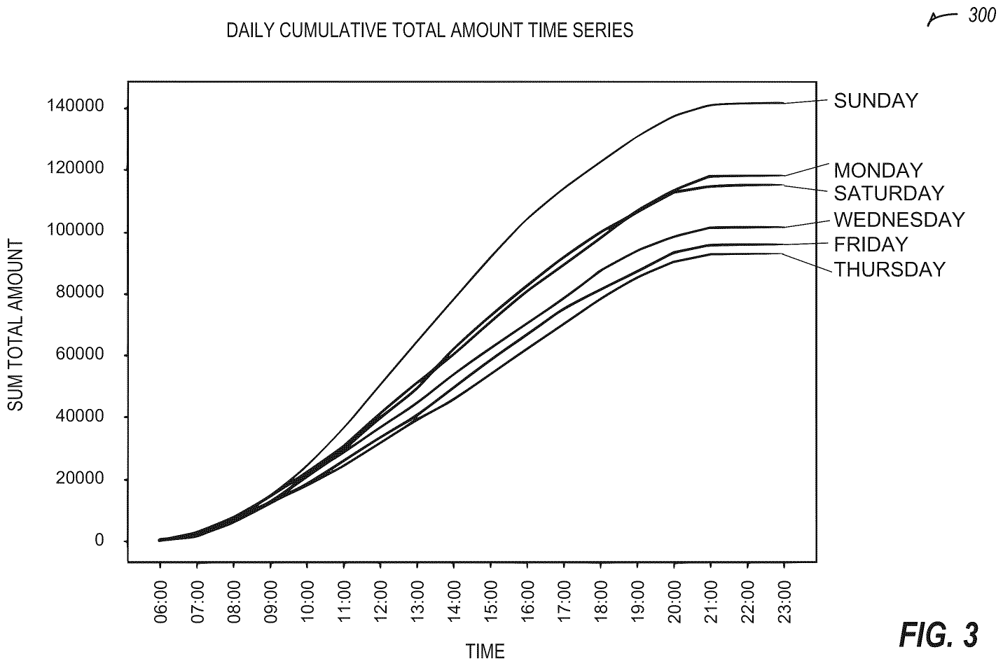

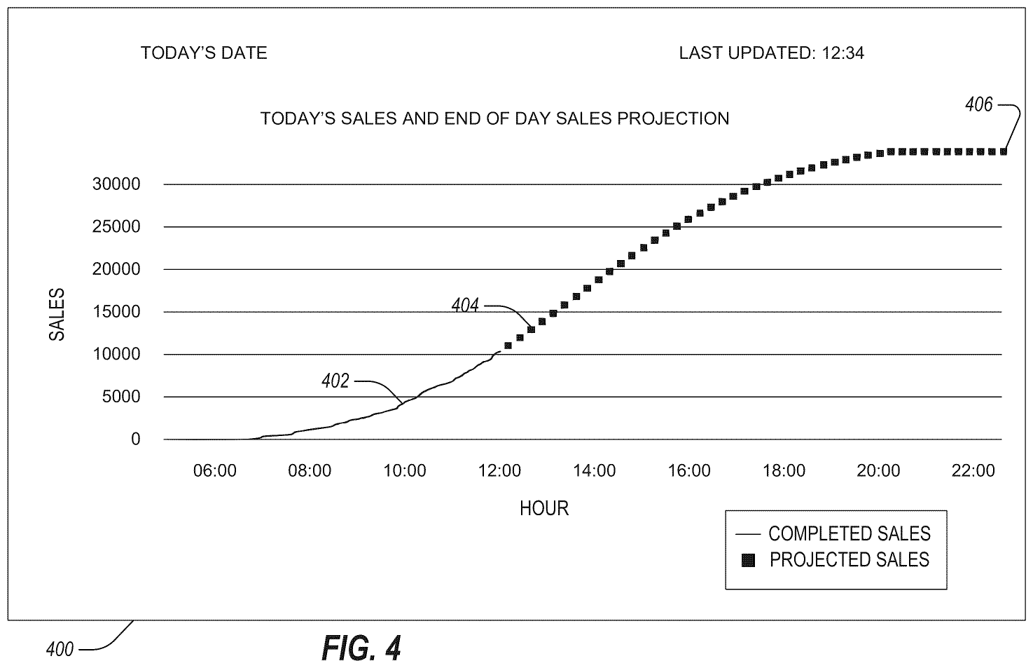

FIG. 2 illustrates generally a user interface 200 for requesting a sales prediction in accordance with some embodiments. The user interface 200 includes one or more components, such as a first component 202 that is configured to allow a user to request an updated sales prediction for a particular time, such as an end of a current day. When the first component 202 is activated, a second component 204 or a third component 206 may be generated (e.g., at a server) and sent for display at the user interface 200. The second component 204 may illustrate a graphical representation (e.g., a graph as shown in FIG. 3 or 4) showing projected sales data. The third component 206 may indicate a numerical value for an end of day sales projection.

The user interface 200 may be a website, and may be displayed at a user device, such as a mobile device (e.g., a phone), a desktop or laptop computer, a tablet, a wearable device, a point-of-sale device, or the like. The user interface 200 may be displayed in response to a user authentication or verification, such as by a user logging into a website. The user interface 200 may be specific to a particular store, in some examples.

FIGS. 3-4 illustrate generally example graphs of projected sales data in accordance with some embodiments.

FIG. 3 illustrates a graph 300 showing daily cumulative total amounts as smoothed time series curves, one for each day of a week. The different curves may be used to set parameters for a particular day, or may be averaged out (e.g., weighted or median) to generate parameters for a particular store with corresponding sales as shown in FIG. 3. The graph 300 may illustrate sales from a start of a sales day (e.g., 6:00) to an end of a sales day (e.g., 22:30). In some examples, the curves of FIG. 3 may represent historical sales data (e.g., not predictive).

FIG. 4 illustrates an example graph 400 showing sales projections in a curve for a particular day. The particular day may be a current day, indicated as “today's date.” The curve may be updated (e.g., on demand or periodically). The curve shows a first portion 402 corresponding to actual sales data for a particular store (e.g., corresponding to sales that have already occurred at the store on the day). The curve shows a second portion 404 showing projected sales (e.g., predicted as described herein). The second portion 404 includes an end time projection 406, which may optionally be shown as a numerical value, in some examples. In some examples, prior projections (e.g., before a current time) may be overlaid on the first portion 402 to show how the curve has tracked over time. As the day progresses, the overlay has a lower error, until when the day reaches the end time, when the real sales data matches the end time projection 406. As the day progresses, the second portion 404 may change (e.g., as more completed sales data is made available). For example, on a day with more than usual sales, the end time projection 406 may be increased, while on a day with fewer than usual sales, the end time projection 406 may be lowered.

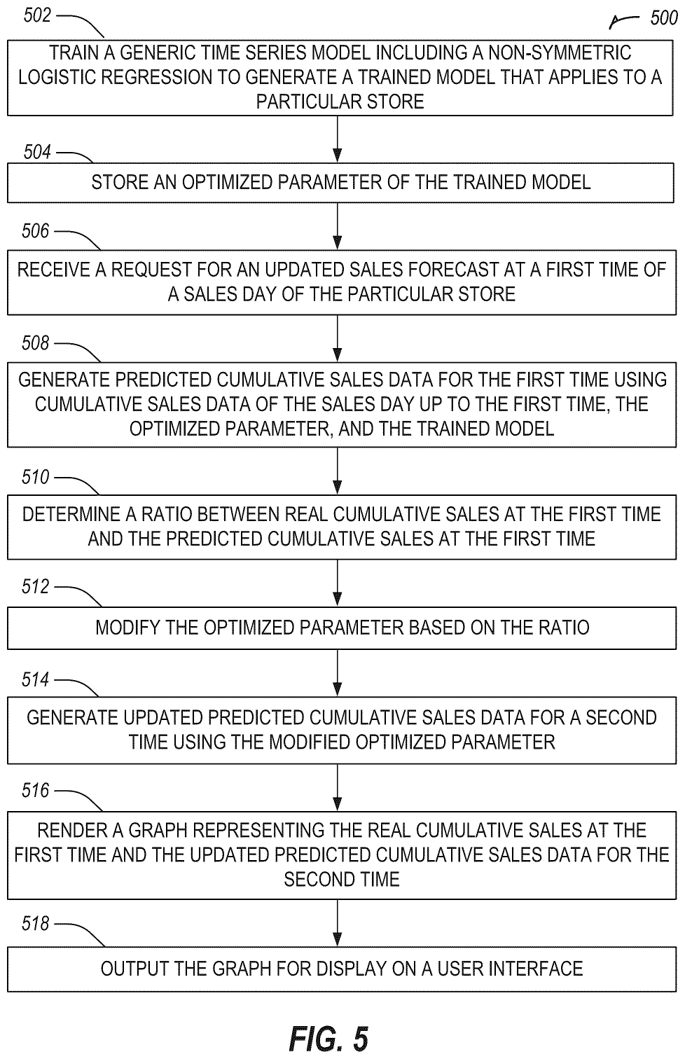

FIG. 5 illustrates generally a flowchart showing a technique 500 for generating a predictive time series of sales data at a store using real-time data in accordance with some embodiments.

The technique 500 includes an operation 502 to train a generic time series model including a non-symmetric logistic regression to generate a trained model that applies to a particular store. Operation 502 may include retrieving historical sales data for the particular store, and optimizing a parameter of the non-symmetric logistic regression. In an example, a left boundary for the non-symmetric logistic regression includes zero sales at a start time of the sales day. In other examples, the left boundary may be non-zero, such as when sales occurred overnight (e.g., a preorder) or after the particular store closed its book the day before.

The non-symmetric logistic regression may be subject to constraints, such as those included in Eq. 1. In this example, where k, L, b, x0, left_{boundary}, and right_{boundary} are function parameters that are fitted to prior observed data, and x is a current time of the sales day. In this example, modifying the optimized parameter based on the ratio may include adjusting L and b based on the ratio. In this example, generating the updated predicted cumulative sales data for the second time using the modified optimized parameter may include using the adjusted L and b.

The technique 500 includes an operation 504 to store the optimized parameter of the trained model. The technique 500 includes an operation 506 to receive a request for an updated sales forecast at a first time of a sales day of the particular store. The technique 500 includes an operation 508 to generate predicted cumulative sales data for the first time using cumulative sales data of the sales day up to the first time, the optimized parameter, and the trained model. The technique 500 includes an operation 510 to determine a relationship, such as a ratio between real cumulative sales at the first time and the predicted cumulative sales at the first time. The technique 500 includes an operation 512 to modify the optimized parameter based on the determined relationship.

The technique 500 includes an operation 514 to generate updated predicted cumulative sales data for a second time using the modified optimized parameter. In some examples, the second time is an end of the sales day. The sales day may correspond to hours that the particular store is open, for example as defined for the particular store, such as 7 am to 8 pm.

The technique 500 includes an operation 516 to render a graphical representation of the real cumulative sales at the first time and the updated predicted cumulative sales data for the second time in response to the request for the updated sales forecast. The technique 500 includes an operation 518 to output the graphical representation for display on a user interface. The graph may include actual sales data from a start time of the sales day up to the first time and predicted sales data from the first time to an end of the sales day (e.g., as shown in FIG. 4). In an example, operation 518 may include outputting a sales amount, a transactions count, a specific item sales, a specific item quantity, or the like.

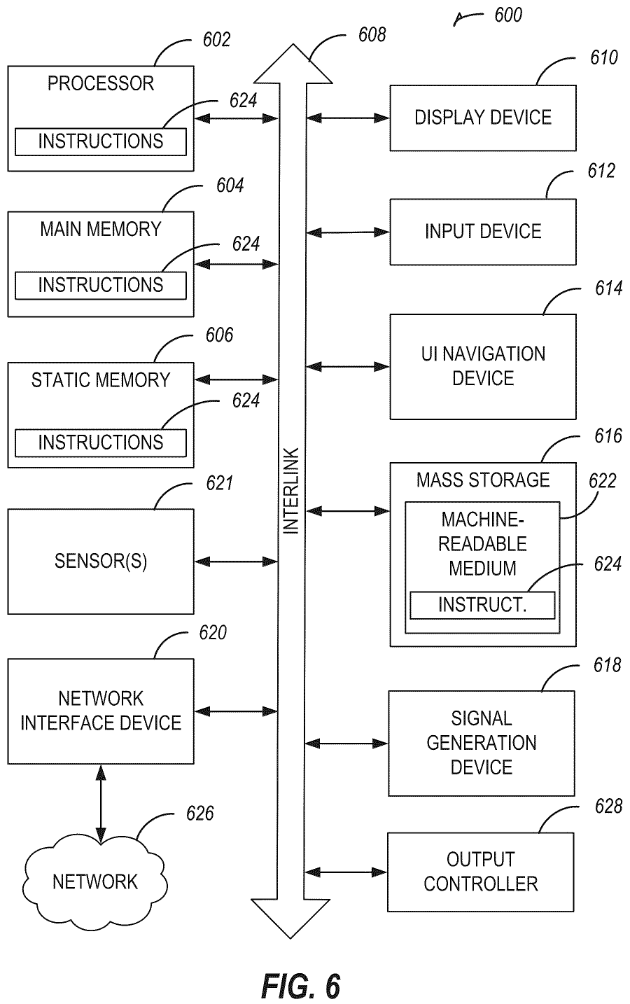

The technique 500 may include outputting the updated predicted cumulative sales data as an end-of-day sales forecast. The accuracy of generating the updated predicted cumulative sales data may be proportional an example, the FIG. 6 illustrates generally an example of a block diagram of a machine 600 upon which any one or more of the techniques discussed herein may perform in accordance with some embodiments. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, alphanumeric input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 that is non-transitory on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, and/or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

Each of these non-limiting examples may stand on its own, or may be combined in various permutations or combinations with one or more of the other examples.

Example 1 is a method comprising: training a generic time series model including a non-symmetric logistic regression to generate a trained model that applies to a particular store by: retrieving historical sales data for the particular store; and optimizing a parameter of the non-symmetric logistic regression; storing the optimized parameter of the trained model; receiving a request for an updated sales forecast at a first time of a sales day of the particular store; generating predicted cumulative sales data for the first time using cumulative sales data of the sales day up to the first time, the optimized parameter, and the trained model; determining a relationship between real cumulative sales at the first time and the predicted cumulative sales at the first time; modifying the optimized parameter based on the determined relationship; generating updated predicted cumulative sales data for a second time using the modified optimized parameter; rendering a graphical representation of the real cumulative sales at the first time and the updated predicted cumulative sales data for the second time; and outputting the graphical representation for display on a user interface in response to the request for the updated sales forecast.

In Example 2, the subject matter of Example 1 includes, wherein a left boundary for the non-symmetric logistic regression includes zero sales at a start time of the sales day.

In Example 3, the subject matter of Examples 1-2 includes, wherein the second time is an end of the sales day.

In Example 4, the subject matter of Examples 1-3 includes, wherein the sales day corresponds to hours that the particular store is open.

In Example 5, the subject matter of Examples 1˜4 includes, outputting the updated predicted cumulative sales data as an end-of-day sales forecast.

In Example 6, the subject matter of Examples 1-5 includes, wherein accuracy of generating the updated predicted cumulative sales data is proportional to an amount of time between the first time and the second time.

In Example 7, the subject matter of Examples 1-6 includes, wherein the non-symmetric logistic regression is subject to constraints including Equation 1, where k, L, b, x0, left_{boundary}, and right_{boundary} are function parameters that are fitted to prior observed data, and x is a current time of the sales day.

In Example 8, the subject matter of Example 7 includes, wherein modifying the optimized parameter based on the determined relationship includes adjusting L and b based on a ratio between the real cumulative sales at the first time and the predicted cumulative sales at the first time.

In Example 9, the subject matter of Example 8 includes, wherein generating the updated predicted cumulative sales data for the second time using the modified optimized parameter includes using the adjusted L and b.

In Example 10, the subject matter of Examples 1-9 includes, wherein the graphical representation includes actual sales data from a start time of the sales day up to the first time and predicted sales data from the first time to an end of the sales day.

Example 11 is at least one machine-readable medium including instructions that when executed by processing circuitry cause the processing circuitry to perform operations comprising: training a generic time series model including a non-symmetric logistic regression to generate a trained model that applies to a particular store by: retrieving historical sales data for the particular store; and optimizing a parameter of the non-symmetric logistic regression; storing the optimized parameter of the trained model; receiving a request for an updated sales forecast at a first time of a sales day of the particular store; generating predicted cumulative sales data for the first time using cumulative sales data of the sales day up to the first time, the optimized parameter, and the trained model; determining a representation between real cumulative sales at the first time and the predicted cumulative sales at the first time; modifying the optimized parameter based on the determined representation; generating updated predicted cumulative sales data for a second time using the modified optimized parameter; rendering a graphical representation of the real cumulative sales at the first time and the updated predicted cumulative sales data for the second time; and outputting the graph for display on a user interface in response to the request for the updated sales forecast.

In Example 12, the subject matter of Example 11 includes, wherein a left boundary for the non-symmetric logistic regression includes zero sales at a start time of the sales day.

In Example 13, the subject matter of Examples 11-12 includes, wherein the second time is an end of the sales day.

In Example 14, the subject matter of Examples 11-13 includes, wherein the sales day corresponds to hours that the particular store is open.

In Example 15, the subject matter of Examples 11-14 includes, outputting the updated predicted cumulative sales data as an end-of-day sales forecast.

In Example 16, the subject matter of Examples 11-15 includes, wherein accuracy of generating the updated predicted cumulative sales data is proportional to an amount of time between the first time and the second time.

In Example 17, the subject matter of Examples 11-16 includes, wherein the non-symmetric logistic regression is subject to constraints including Equation 1, where k, L, b, x0, left_{boundary}, and right_{boundary} are function parameters that are fitted to prior observed data, and x is a current time of the sales day.

In Example 18, the subject matter of Example 17 includes, wherein modifying the optimized parameter based on the determined relationship includes adjusting L and b based on a ratio between the real cumulative sales at the first time and the predicted cumulative sales at the first time.

In Example 19, the subject matter of Example 18 includes, wherein generating the updated predicted cumulative sales data for the second time using the modified optimized parameter includes using the adjusted L and b.

In Example 20, the subject matter of Examples 11-19 includes, wherein the graphical representation includes actual sales data from a start time of the sales day up to the first time and predicted sales data from the first time to an end of the sales day.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A method comprising:
training a generic time series model including a non-symmetric logistic regression to generate a trained model that applies to a particular store by:
retrieving historical sales data for the particular store; and
optimizing a parameter of the non-symmetric logistic regression;
storing the optimized parameter of the trained model;
receiving a request for an updated sales forecast at a first time of a sales day of the particular store;
generating predicted cumulative sales data for the first time using cumulative sales data of the sales day up to the first time, the optimized parameter, and the trained model;
determining a relationship between real cumulative sales at the first time and the predicted cumulative sales at the first time;
modifying the optimized parameter based on the determined relationship;
generating updated predicted cumulative sales data for a second time using the modified optimized parameter;
rendering a graphical representation of the real cumulative sales at the first time and the updated predicted cumulative sales data for the second time; and
outputting the graphical representation for display on a user interface in response to the request for the updated sales forecast.

2. The method of claim 1, wherein a left boundary for the non-symmetric logistic regression includes zero sales at a start time of the sales day.

3. The method of claim 1, wherein the second time is an end of the sales day.

4. The method of claim 1, wherein the sales day corresponds to hours that the particular store is open.

5. The method of claim 1, further comprising outputting the updated predicted cumulative sales data as an end-of-day sales forecast.

6. The method of claim 1, wherein accuracy of generating the updated predicted cumulative sales data is proportional to an amount of time between the first time and the second time.

7. The method of claim 1, wherein the non-symmetric logistic regression is subject to constraints including:
$$\{ \begin{matrix}0 & x < {left}_{boundary} \\ L * \frac{1}{1 + {e}^{k * ( x - x 0 )}} + b & {left}_{boundary} \leq x \leq {right}_{boundary} \\ L * \frac{1}{1 + {e}^{k * ( {right}_{boundary} - x 0 )}} + b & x \geq {right}_{boundary}\end{matrix}$$
where k, L, b, x0, left_{boundary}, and right_{boundary} are function parameters that are fitted to prior observed data, and x is a current time of the sales day.

8. The method of claim 7, wherein modifying the optimized parameter based on the determined relationship includes adjusting L and b based on a ratio between the real cumulative sales at the first time and the predicted cumulative sales at the first time.

9. The method of claim 8, wherein generating the updated predicted cumulative sales data for the second time using the modified optimized parameter includes using the adjusted L and b.

10. The method of claim 1, wherein the graphical representation includes actual sales data from a start time of the sales day up to the first time and predicted sales data from the first time to an end of the sales day.

11. At least one machine-readable medium including instructions that when executed by processing circuitry cause the processing circuitry to perform operations comprising:
training a generic time series model including a non-symmetric logistic regression to generate a trained model that applies to a particular store by:
retrieving historical sales data for the particular store; and
optimizing a parameter of the non-symmetric logistic regression;
storing the optimized parameter of the trained model;
receiving a request for an updated sales forecast at a first time of a sales day of the particular store;
generating predicted cumulative sales data for the first time using cumulative sales data of the sales day up to the first time, the optimized parameter, and the trained model;
determining a relationship between real cumulative sales at the first time and the predicted cumulative sales at the first time;
modifying the optimized parameter based on the determined relationship;
generating updated predicted cumulative sales data for a second time using the modified optimized parameter;
rendering a graphical representation of the real cumulative sales at the first time and the updated predicted cumulative sales data for the second time; and
outputting the graphical representation for display on a user interface in response to the request for the updated sales forecast.

12. The at least one machine-readable medium of claim 11, wherein a left boundary for the non-symmetric logistic regression includes zero sales at a start time of the sales day.

13. The at least one machine-readable medium of claim 11, wherein the second time is an end of the sales day.

14. The at least one machine-readable medium of claim 11, wherein the sales day corresponds to hours that the particular store is open.

15. The at least one machine-readable medium of claim 11, further comprising outputting the updated predicted cumulative sales data as an end-of-day sales forecast.

16. The at least one machine-readable medium of claim 11, wherein accuracy of generating the updated predicted cumulative sales data is proportional to an amount of time between the first time and the second time.

17. The at least one machine-readable medium of claim 11, wherein the non-symmetric logistic regression is subject to constraints including:
$$\{ \begin{matrix}0 & x < {left}_{boundary} \\ L * \frac{1}{1 + {e}^{k * ( x - x 0 )}} + b & {left}_{boundary} \leq x \leq {right}_{boundary} \\ L * \frac{1}{1 + {e}^{k * ( {right}_{boundary} - x 0 )}} + b & x \geq {right}_{b o u n d a r y}\end{matrix}$$
where k, L, b, x0, left_{boundary}, and right_{boundary} are function parameters that are fitted to prior observed data, and x is a current time of the sales day.

18. The at least one machine-readable medium of claim 17, wherein modifying the optimized parameter based on the determined relationship includes adjusting L and b based on a ratio between the real cumulative sales at the first time and the predicted cumulative sales at the first time.

19. The at least one machine-readable medium of claim 18, wherein generating the updated predicted cumulative sales data for the second time using the modified optimized parameter includes using the adjusted L and b.

20. The at least one machine-readable medium of claim 11, wherein the graphical representation includes actual sales data from a start time of the sales day up to the first time and predicted sales data from the first time to an end of the sales day.
